(19) United States
(12) Patent Application Publication
(10) Pub. No.: US 2026/0051299 A1
(43) Pub. Date: Feb. 19, 2026

(54) DISPLAY DEVICE AND DRIVING METHOD THEREOF

(71) Applicant: LG Display Co., Ltd., Seoul (KR)

(72) Inventors: Dae Seok OH, Paju-si, Gyeonggi-do (KR); Seung Hwan SHIN, Paju-si, Gyeonggi-do (KR)

(73) Assignee: LG Display Co., Ltd., Seoul (KR)

(21) Appl. No.: 19/285,027

(22) Filed: Jul. 30, 2025

(30) Foreign Application Priority Data
Aug. 14, 2024 (KR) 10-2024-0109169

(51) Int. Cl. G09G 3/3291

(52) U.S. Cl. CPC G09G 3/3291; G09G 2300/0452; G09G 2300/0819; G09G 2310/0245; G09G 2310/0251; G09G 2310/0297; G09G 2310/08; G09G 2330/021

(57) ABSTRACT

A display device includes a source driver outputting a first data voltage via a data output channel and a first pre-charge voltage via an auxiliary output channel in a first time period during a refresh frame and outputting a second data voltage via the data output channel and a second pre-charge voltage via the auxiliary output channel in a second time period following the first time period during the refresh frame; and a display panel including a first pixel in an odd pixel row and connected to a first data line to receive the first data voltage in the first time period and the second pre-charge voltage in the second time period, and an adjacent second pixel in an even pixel row and connected to a second data line to receive the first pre-charge voltage in the first time period and the second data voltage in the second time period.

### CROSS-REFERENCE TO RELATED APPLICATION

This application claims the benefit of Korean Patent Application No. 10-2024-0109169, filed on Aug. 14, 2024, which is hereby incorporated by reference as if fully set forth herein.

### BACKGROUND

### Field of the Disclosure

The present disclosure relates to a display device and a driving method thereof.

### Discussion of the Related Art

Display devices include a plurality of pixels arranged as a matrix type and implement a target luminance corresponding to a data voltage by using the pixels in a display panel. Each of the pixels includes a light emitting element, and a target luminance is implemented with the amount of light emission by the light emitting element.

A pixel is supplied with a data voltage output from a source driver through a data line. A level of a data voltage supplied through a data line may temporally and continuously vary. Image quality implemented in pixels depends on a data slew of a data voltage. The data slew may be defined as a speed at which an electric potential of a data line follows a target level of a data voltage.

To improve the data slew, a method of extending an output-enable range of a data voltage or increasing a length of one horizontal time for driving of one pixel row may be considered, but such methods are unfavorable for power consumption.

### SUMMARY

Therefore, an object of the present disclosure is to provide a display device and a driving method thereof that substantially obviate one or more of the limitations and disadvantages associated with the related art.

For example, the present disclosure provides a display device and a driving method thereof which may improve a data slew to enhance image quality with a low power consumption.

Additional advantages and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display device includes: a display panel including a first pixel in a first pixel row and connected to a first data line and including a second pixel adjacent to the first pixel, in a second pixel row, and connected to a second data line; a source driver including a data output channel configured to output a first data voltage to be supplied to the first data line in a first time period during a refresh frame and to output a second data voltage to be supplied to the second data line in a second time period following the first time period during the refresh frame, and an auxiliary output channel configured to output a first pre-charge voltage to be supplied to the second data line in the first time period and to output a second pre-charge voltage to be supplied to the first data line in the second time period; and a multiplexer switch circuit configured to connect the data output channel to the first data line and connect the auxiliary output channel to the second data line in the first time period, and connect the data output channel to the second data line and connect the auxiliary output channel to the first data line in the second time period.

In another aspect of the present disclosure, a method of driving a display device is disclosed where the display device includes a display panel having a first pixel in a first pixel row and connected to a first data line and having a second pixel adjacent to the first pixel, in a second pixel row, and connected to a second data line. The method includes: in a first time period during a refresh frame, providing a first data voltage to the first data line through a data output channel of a source driver and providing a first pre-charge voltage to the second data line through an auxiliary output channel of the source driver; in a second time period following the first time period during the refresh frame, providing a second data voltage to the second data line through the data output channel and providing a second pre-charge voltage to the first data line through the auxiliary output channel; connecting the data output channel to the first data line and connecting the auxiliary output channel to the second data line in the first time period during the refresh frame; and connecting the data output channel to the second data line and connecting the auxiliary output channel to the first data line in the second time period during the refresh frame.

In yet another aspect of the present disclosure, a display device includes: a source driver having a first data output channel and a first auxiliary output channel, the source driver being configured to output a first data voltage via the first data output channel and a first pre-charge voltage via the first auxiliary output channel in a first time period during a refresh frame and to output a second data voltage via the first data output channel and a second pre-charge voltage via the first auxiliary output channel in a second time period following the first time period during the refresh frame; and a display panel including a plurality of pixels, including a first pixel in a first column in an odd pixel row and connected to a first data line configured to receive the first data voltage in the first time period and the second pre-charge voltage in the second time period, and a second pixel in the first column in an even pixel row and connected to a second data line configured to receive the first pre-charge voltage in the first time period and the second data voltage in the second time period.

It is to be understood that both the foregoing general description and the following detailed description are by way of example and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain the principle of the disclosure. In the drawings:

FIG. 1 is a diagram illustrating a display device according to an example embodiment of the present disclosure;

FIG. 2 is a diagram illustrating a portion of an example pixel array included in an active area;

FIG. 3 is a diagram illustrating an example of variable refresh rate (VRR) technology applied to a display device according to an example embodiment of the present disclosure;

FIG. 4 is a diagram schematically illustrating an example configuration where a source driver is connected to a pixel array through a multiplexer switch circuit;

FIGS. 5 to 8 are diagrams illustrating a driving timing and a connection configuration of a multiplexer switch circuit according to a first example embodiment for improving a data slew of a data line with respect to various image patterns;

FIG. 9A is a diagram illustrating an operation state of a multiplexer switch circuit implemented at a first time of FIGS. 6 and 8;

FIG. 9B is a diagram illustrating an operation state of a multiplexer switch circuit implemented at a second time of FIGS. 6 and 8;

FIG. 10 is a diagram illustrating an example connection configuration of a pixel applied to a display device according to an example embodiment of the present disclosure;

FIG. 11 is a diagram illustrating a driving waveform of a pixel in a refresh frame;

FIG. 12 is a diagram illustrating a driving waveform of a pixel in a skip frame;

FIG. 13 is a diagram illustrating some elements of a multiplexer switch circuit and a source driver connected thereto according to a first example embodiment;

FIG. 14 is a diagram illustrating a data output and an auxiliary output of a source driver during a refresh frame and a skip frame;

FIG. 15A is a diagram illustrating an operation state of a multiplexer switch circuit implemented at a first time of a refresh frame;

FIG. 15B is a diagram illustrating an operation state of a multiplexer switch circuit implemented at a second time of the refresh frame;

FIG. 15C is a diagram illustrating an operation state of a multiplexer switch circuit implemented in a skip frame;

FIG. 16 is a diagram illustrating another example connection configuration of a pixel applied to a display device according to an example embodiment of the present disclosure;

FIG. 17 is a diagram illustrating a case where a pre-charge voltage and an on-bias stress (OBS) voltage are supplied to a data line through one auxiliary output channel, at different timings of a refresh frame;

FIG. 18 is a diagram illustrating a case where a line stabilization voltage and an OBS voltage are supplied to a data line through one auxiliary output channel, at different timings of a skip frame;

FIG. 19 is a diagram illustrating an operation state of a multiplexer switch circuit for selectively outputting a line stabilization voltage and an OBS voltage in a skip frame; and

FIG. 20 is a diagram illustrating a connection configuration of a multiplexer switch circuit according to a second example embodiment for improving a data slew of a data line.

### DETAILED DESCRIPTION

Hereinafter, the present disclosure will be described more fully with reference to the accompanying drawings, in which example embodiments of the disclosure are shown. The disclosure may, however, be embodied in many different forms and should not be construed as being limited to the embodiments set forth herein. Rather, these example embodiments are provided so that this disclosure will be more thorough and complete, and will more fully convey the various concepts of the disclosure to those skilled in the art. Further, the protective scope of the present disclosure may be defined by the claims and their equivalents.

The shapes, sizes, ratios, angles, numbers, and the like disclosed in the drawings for description of various example embodiments of the present disclosure are merely examples, and the present disclosure is not limited thereto. Throughout this specification, the same elements are denoted by the same reference numerals unless otherwise specified.

As used herein, the terms “comprise”, “having,” “including”, and the like suggest that other parts can be added unless a more limiting term like “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a positional relationship, for example, where a positional relation between two parts is described as “on˜”, “over˜”, “under˜”, and “next˜”, one or more other parts may be disposed between the two parts unless a more limiting term like “just” or “direct” is used.

It should be understood that, although such terms as “first”, “second”, etc., may be used herein to describe various elements, these elements should not be limited by these terms. These terms are only used to refer to one element separately from another. For example, a first element could be termed a second element, and, similarly, a second element could be termed a first element, without departing from the scope of the present disclosure.

In the following description, where the detailed description of the relevant known function or configuration may unnecessarily obscure a feature or aspect of the present disclosure, the detailed description of such known function or configuration may be omitted. Hereinafter, example embodiments of the present disclosure will be described in detail with reference to the accompanying drawings.

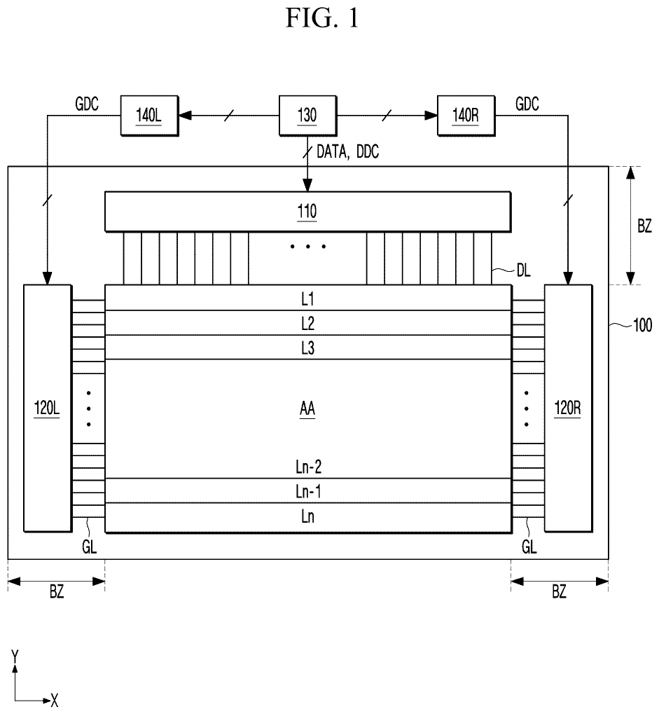

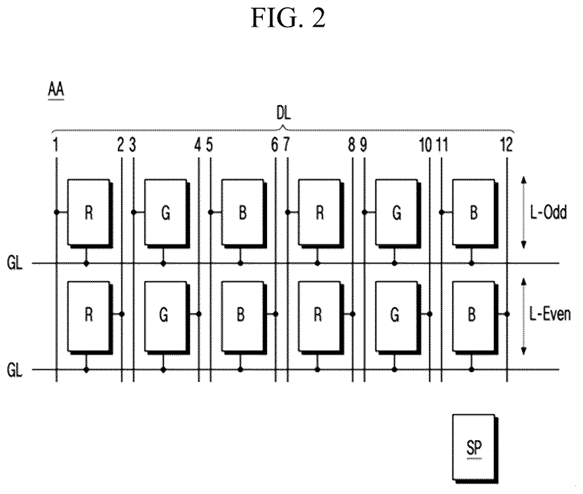

FIG. 1 is a diagram illustrating a display device according to an example embodiment of the present disclosure. FIG. 2 is a diagram illustrating a portion of an example pixel array included in an active area.

As shown in FIGS. 1 and 2, the display device according to an example embodiment of the present disclosure may be an organic light emitting display device, but the present disclosure is not limited thereto. A display panel 100 may include an active area AA which is configured to reproduce an input image. The active area AA may include a pixel array which displays pixel data (hereinafter referred to as “image data”) DATA of an input image. The pixel array may include a plurality of data lines DL, a plurality of gate lines GL intersecting with the data lines DL, and a plurality of pixels SP.

The pixels SP may be arranged on the active area AA in a matrix type defined by intersections between the data lines DL and the gate lines GL. The pixels SP may be arranged as various types, such as a stripe type and a diamond type, on the active area AA based on positions of the pixels SP emitting lights of the same color.

The pixel array may include a plurality of pixel columns and a plurality of pixel rows L1 to Ln intersecting with the pixel columns. Each of the pixel columns may include pixels SP which are arranged in a Y-axis direction. A pixel row may include pixels SP which are arranged in an X-axis direction. One vertical period may be one frame period for writing image data DATA of one frame in all pixels of the active area. One horizontal period may be a time obtained by dividing one frame period by the number of pixel rows L1 to Ln. One horizontal period may be a time for writing the image data DATA of one pixel row, sharing a gate line GL, in pixels SP of one pixel row.

The pixels SP may include a first pixel (R in FIG. 2) which generates red (R) light, a second pixel (G in FIG. 2) which generates green (G) light, and a third pixel (B in FIG. 2) which generates blue (B) light, for various color combinations. The pixels SP may further include a fourth pixel which generates white (W) light. The first to third pixels or the first to fourth pixels may configure one unit pixel.

R, G, and B pixels may configure an odd pixel row L-Odd and an even pixel row L-Even. In the odd pixel row L-Odd, R, G, and B pixels may be connected to odd data lines like DL1, DL3, DL5, DL7, DL9, and DL11, and in the even pixel row L-Even, R, G, and B pixels may be connected to odd data lines like DL2, DL4, DL6, DL8, DL10, and DL12. Two pixels of the same color, which configure the same pixel column and are disposed adjacent to each other, may be connected to different data lines. Such a connection structure may be easy to implement low power consumption compared to a conventional connection structure where two pixels of the same color are connected to the same data line in common.

Each of the pixels SP may be implemented with a pixel circuit connected to a data line DL and a gate line GL. The pixel circuit may include a light emitting element, a driving transistor, one or more switch transistors, and a capacitor. The light emitting element may be implemented as an organic light emitting diode (OLED). A driving current applied to the light emitting element may be controlled based on a gate-source voltage of the driving transistor. The gate-source voltage of the driving transistor may be determined by a data voltage corresponding to the image data DATA.

The pixel circuit may sample a threshold voltage of the driving transistor in the middle of a pixel programming operation, which is performed in one frame period, and may allow a sampled threshold voltage to be reflected in a gate-source voltage (hereinafter referred to as Vgs) of the driving transistor. This may prevent or suppress a driving current from being distorted due to a threshold voltage variation of the driving transistor.

The pixel circuit may be implemented as a hybrid type. In a hybrid-type pixel circuit, semiconductor layers of some transistors may include a low-temperature polycrystalline silicon (hereinafter referred to as LTPS), and semiconductor layers of the other transistors may be configured with an oxide.

The pixel circuit may be driven based on the variable refresh rate (VRR) technology. The VRR technology may vary a refresh rate of image data DATA based on an attribute of an image. According to the VRR technology, as a change in image decreases, a data refresh cycle may increase, and thus, power consumption may be reduced.

To implement the VRR technology, one or more skip frames may be provided between adjacent refresh frames. A data refresh operation may be performed in the refresh frame and not in the skip frame. A refresh rate (i.e., a frame frequency) may be determined based on the number of skip frames provided between adjacent refresh frames.

A data refresh operation including pixel initialization and data programming may be performed in a refresh frame. The light emitting element may be turned off when performing a data refresh operation. At this time, an anode reset operation may be performed where the light emitting element is initialized into an anode reset voltage may be performed.

A data refresh operation on the pixels SP may be omitted (or skipped) in a skip frame, and a data refresh condition Vgs (the driving current), which is set in a refresh frame, may be maintained in the skip frame. An anode reset operation for turning off the light emitting element may be performed in the skip frame. Accordingly, a time length where the light emitting element is turned on in the skip frame may be substantially equal to a time length where the light emitting element is turned on in the refresh frame.

In each of the refresh frame and the skip frame, while the anode reset operation is being performed, an on-bias stress (OBS) operation may be performed on the driving transistor.

In the hybrid-type pixel circuit according to the present example embodiment, the OBS operation may be for preventing or suppressing an image quality defect caused by a hysteresis characteristic of the driving transistor. When a grayscale value of the image data DATA is changed from black to white, a grayscale response time may increase in a first frame where a white image is reproduced, due to a time for varying the hysteresis characteristic of the driving transistor. Thus, a dim first frame (DFF) phenomenon may occur. At this time, when the Vgs of the driving transistor increases by applying an OBS voltage to one electrode of the driving transistor, a DFF characteristic may be alleviated. This may be referred to as an OBS operation.

Touch sensors may be further disposed on the display panel 100. The touch sensors may be arranged as an on-cell or add-on type on the active area AA of the display panel 100, or may be implemented as in-cell type touch sensors embedded in the pixel array. A touch input may be sensed through the pixels SP even without the touch sensors, and in this case, the touch sensors may be omitted.

A display panel driver may include a source driver 110 and gate drivers 120L and 120R. The display panel driver may write the image data DATA in the pixels SP of the display panel 100, based on a control by a timing controller 130.

A source driver 110 may convert the image data DATA, received from the timing controller 130, into gamma compensation voltages by using a digital-to-analog converter (DAC) to generate data voltages. The source driver 110 may supply the data voltages to the data lines DL. The data voltages may be supplied to the data lines DL and may be applied to gate electrodes of the driving transistors through the switch transistors of the subpixels SP. The source driver 110 may be implemented with a plurality of source drive integrated circuits (ICs).

To reduce an RC delay deviation occurring in the display panel 100 including a large active area, the gate drivers 120L and 120R may be implemented as a double bank type. That is, the gate drivers 120L and 120R may be provided as a gate driver in panel (GIP) type respectively in left and right bezel regions BZ disposed outside the active area AA of the display panel 100 and may supply gate signals having the same phase to the same gate line GL at respective sides of the display panel 100. The gate drivers 120L and 120R may include a first-side gate driver 120L, which is disposed in the left bezel region BZ of the display panel 100, and a second-side gate driver 120R, which is disposed in the right bezel region BZ of the display panel 100.

The gate drivers 120L and 120R at both sides may sequentially supply a gate signal to the gate lines GL, based on a control by the timing controller 130. The gate signal may select pixel rows L1 to Ln charged with data voltages and may simultaneously activate pixels SP disposed in a corresponding pixel row. The gate drivers 120L and 120R may output a gate signal for pixel driving and may shift the gate signal in a pixel row unit. The gate signal may include a plurality of scan signals and an emission control signal which swing between an on level and an off level. The gate drivers 120L and 120R at both sides may include a plurality of scan drivers (not shown) which generate a plurality of scan signals and an EM driver (not shown) which generates an emission control signal.

The timing controller 130 may receive video data DATA and one or more timing signals, synchronized with the video data DATA, from a host system (not shown). The timing signals may include a vertical synchronization signal Vsync, a horizontal synchronization signal Hsync, a clock signal DCLK, and a data enable signal DE. The vertical synchronization signal Vsync may define a vertical period. The horizontal synchronization signal Hsync may define a horizontal period. The data enable signal DE may define a time where the video data DATA is transferred, in a vertical period or a horizontal period. The vertical period and the horizontal period may be determined by a method of counting the data enable signal DE. Thus, the vertical synchronization signal Vsync and the horizontal synchronization signal Hsync may be omitted.

The timing controller 130 may generate a source timing control signal DDC for controlling an operation timing of the source driver 110 and a gate timing control signal GDC for controlling an operation timing of the gate drivers 120L and 120R, based on the timing signals Vsync, Hsync, and DE received from the host system.

The host system may be one of a television (TV), a set-top box, a navigation system, a personal computer (PC), a home theater, an automotive display system, a mobile device, and a wearable device. In the mobile device and the wearable device, the source driver 110, the timing controller 130, and level shifters 140L and 140R may be integrated into one drive IC.

The level shifters 140L and 140R may convert a voltage of the gate timing control signal GDC, output from the timing controller 130, into an on-level voltage and an off-level voltage and may supply the on-level voltage and the off-level voltage to the gate drivers 120L and 120R.

The level shifters 140L and 140R may include a first level shifter 140L, which is connected to the first-side gate driver 120L through first signal lines, and a second level shifter, 140R which is connected to the second-side gate driver 120R through second signal lines.

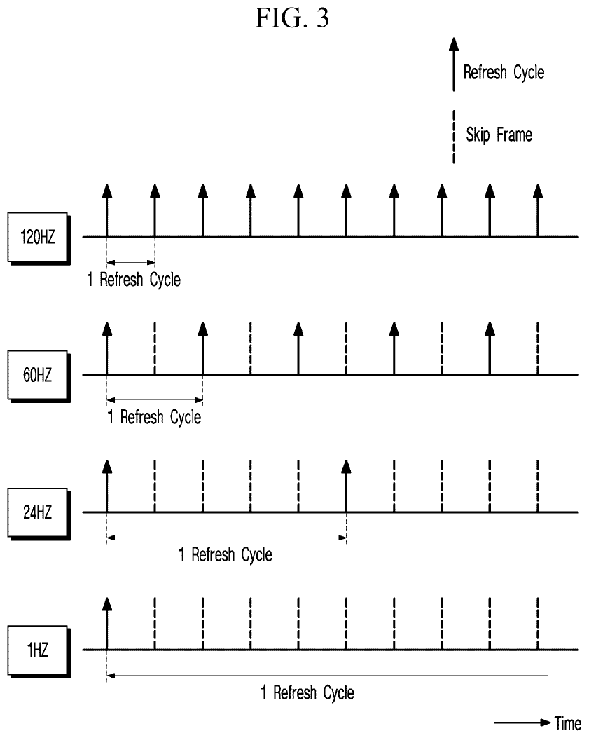

FIG. 3 is a diagram illustrating an example of VRR technology applied to a display device according to an example embodiment of the present disclosure.

As shown in FIG. 3, a data refresh cycle implemented in pixels of a display panel may vary based on an attribute of an input image. The data refresh cycle may decrease when the amount of variation of an image is large, and when the amount of variation of the image is small, the data refresh cycle may increase. As the data refresh cycle increases, low-speed driving may be performed, and as the data refresh cycle decreases, high-speed driving may be performed.

The data refresh cycle may be 1/frame frequency. For example, the data refresh cycle may be 1 sec/120 in 120 Hz, 1 sec/60 in 60 Hz, 1 sec/24 in 24 Hz, and 1 sec in 1 Hz.

The number of skip frames provided between two adjacent refresh frames may vary based on a frame frequency. For example, the number of skip frames may be 0 in 120 Hz, 1 in 60 Hz, 4 in 24 Hz, and 119 in 1 Hz.

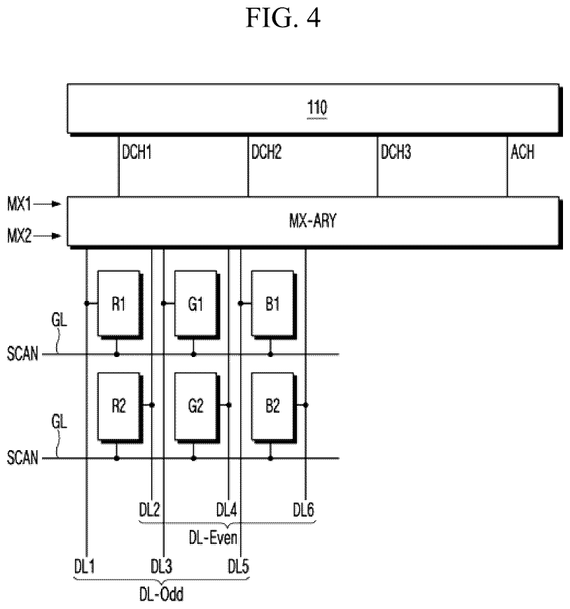

FIG. 4 is a diagram schematically illustrating an example configuration where a source driver is connected to a pixel array through a multiplexer switch circuit.

As shown in FIG. 4, in a display device according to an example embodiment of the present disclosure, a multiplexer switch circuit MX-ARY may be provided and may electrically connect a pixel array for low power consumption to a source driver 110 for improving a data slew.

In the pixel array, two pixels of the same color, which configure the same pixel column and are disposed adjacent to each other, may be connected to different data lines. For example, first and second data lines DL1 and DL2 may be respectively connected to R pixels R1 and R2 which are disposed adjacent to each other in the same pixel column, third and fourth data lines DL3 and DL4 may be respectively connected to G pixels G1 and G2 which are disposed adjacent to each other in the same pixel column, and fifth and sixth data lines DL5 and DL6 may be respectively connected to B pixels B1 and B2 which are disposed adjacent to each other in the same pixel column.

The source driver 110 may further include an auxiliary output channel ACH for improving a data slew, in addition to data output channels DCH1, DCH2, and DCH3.

The data output channels DCH1, DCH2, and DCH3 may output a first data voltage, which is to be supplied to odd data lines DL-Odd, for a first time of a refresh frame, and may output a second data voltage, which is to be supplied to even data lines DL-Even, for a second time succeeding the first time in the refresh frame. The first time of the refresh frame may be a data programming time for pixels R1, G1, and B1 of a first pixel row, and the second time of the refresh frame may be a data programming time for pixels R2, G2, and B2 of a second pixel row.

The auxiliary output channel ACH may output a first pre-charge voltage, which is to be supplied to the even data lines DL-Even, for the first time of the refresh frame, and may output a second pre-charge voltage, which is to be supplied to the odd data lines DL-Odd, for the second time of the refresh frame. The first pre-charge voltage may be for increasing a data slew of the even data lines DL-Even in the refresh frame and may vary over time within a predetermined pre-charge voltage range. Also, the second pre-charge voltage may be for increasing a data slew of the odd data lines DL-Odd in a current refresh frame and may vary over time within the predetermined pre-charge voltage range. Here, the predetermined pre-charge voltage range may be greater than a minimum data voltage output from the source driver 110 and less than a maximum data voltage output therefrom. In other words, the low end of the predetermined pre-charge voltage range may be greater than the minimum data voltage output from the source driver 110, and the high end of the predetermined pre-charge voltage may be less than the maximum data voltage output from the source driver 110.

The multiplexer switch circuit MX-ARY may connect the data output channels DCH1, DCH2, and DCH3 to the odd data lines DL-Odd and may connect the auxiliary output channel ACH to the even data lines DL-Even for the first time of the refresh frame, based on multiplexer control signals MX1 and MX2.

The multiplexer switch circuit MX-ARY may connect the data output channels DCH1, DCH2, and DCH3 to the even data lines DL-Even and may connect the auxiliary output channel ACH to the odd data lines DL-Odd for the second time of the refresh frame, based on the multiplexer control signals MX1 and MX2.

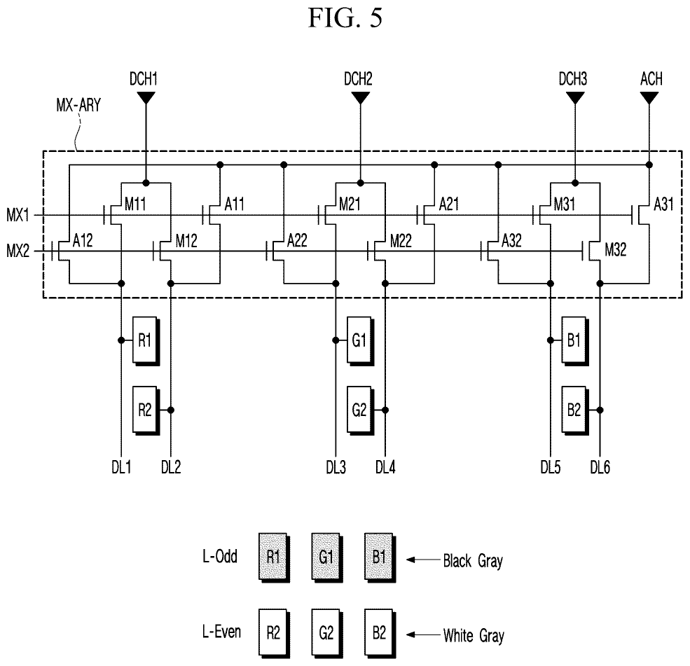

FIGS. 5 to 8 are diagrams illustrating a driving timing and a connection configuration of a multiplexer switch circuit according to a first example embodiment for improving a data slew of a data line with respect to various image patterns.

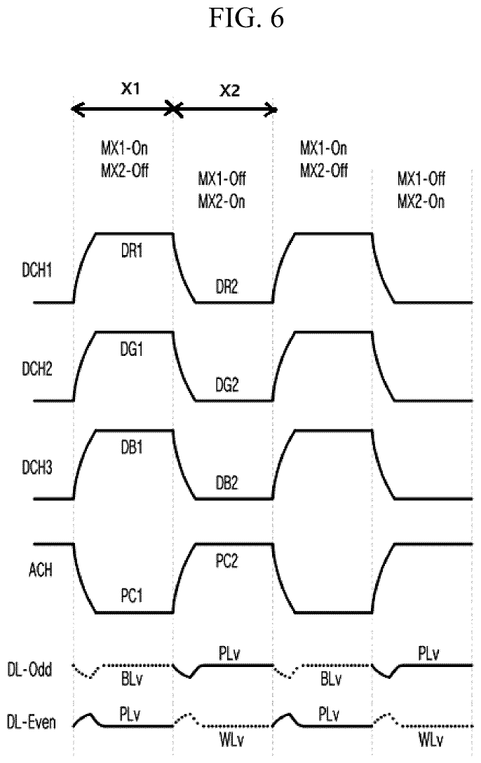

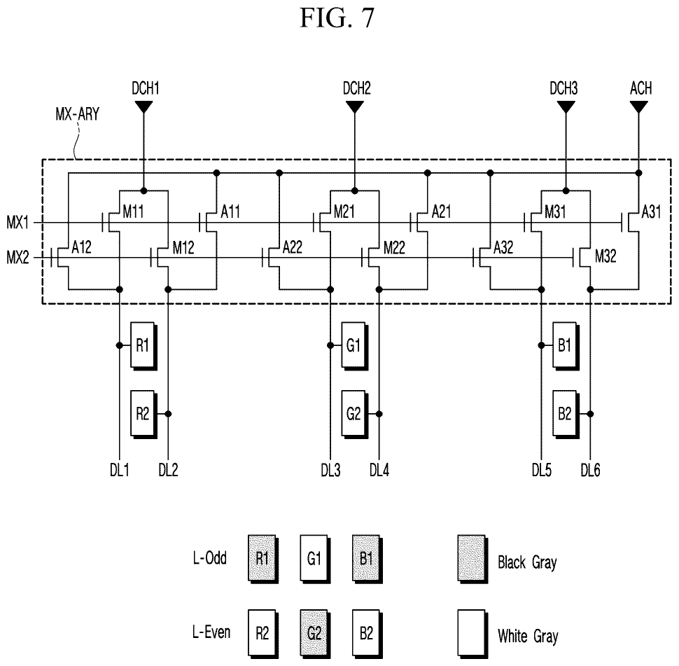

FIG. 9A is a diagram illustrating an operation state of a multiplexer switch circuit implemented at a first time X1 in FIGS. 6 and 8. FIG. 9B is a diagram illustrating an operation state of a multiplexer switch circuit implemented at a second time X2 in FIGS. 6 and 8.

As shown in FIGS. 5 and 7, a multiplexer switch circuit MX-ARY according to a first example embodiment may include a first group switch which drives first and second data lines DL1 and DL2, a second group switch which drives third and fourth data lines DL3 and DL4, and a third group switch which drives fifth and sixth data lines DL5 and DL6.

The first group switch may include first and second multiplexer switches M11 and M12 and first and second auxiliary switches A11 and A12.

The first multiplexer switch M11 may be connected between the first data output channel DCH1 and the first data line DL1 and may be turned on or off based on a first multiplexer control signal MX1. The first auxiliary switch A11 may be connected between the auxiliary output channel ACH and the second data line DL2 and may be turned on or off based on the first multiplexer control signal MX1.

The second multiplexer switch M12 may be connected between the first data output channel DCH1 and the second data line DL2 and may be turned on or off based on a second multiplexer control signal MX2. The second auxiliary switch A12 may be connected between the auxiliary output channel ACH and the first data line DL1 and may be turned on or off based on the second multiplexer control signal MX2.

Moreover, the second group switch may include third and fourth multiplexer switches M21 and M22 and third and fourth auxiliary switches A21 and A22.

The third multiplexer switch M21 may be connected between the second data output channel DCH2 and the third data line DL3 and may be turned on or off based on the first multiplexer control signal MX1. The third auxiliary switch A21 may be connected between the auxiliary output channel ACH and the fourth data line DL4 and may be turned on or off based on the first multiplexer control signal MX1.

The fourth multiplexer switch M22 may be connected between the second data output channel DCH2 and the fourth data line DL4 and may be turned on or off based on the second multiplexer control signal MX2. The fourth auxiliary switch A22 may be connected between the auxiliary output channel ACH and the third data line DL3 and may be turned on or off based on the second multiplexer control signal MX2.

Moreover, the third group switch may include fifth and sixth multiplexer switches M31 and M32 and fifth and sixth auxiliary switches A31 and A32.

The fifth multiplexer switch M31 may be connected between the third data output channel DCH3 and the fifth data line DL5 and may be turned on or off based on the first multiplexer control signal MX1. The fifth auxiliary switch A31 may be connected between the auxiliary output channel ACH and the sixth data line DL6 and may be turned on or off based on the first multiplexer control signal MX1.

The sixth multiplexer switch M32 may be connected between the third data output channel DCH3 and the sixth data line DL6 and may be turned on or off based on the second multiplexer control signal MX2. The sixth auxiliary switch A32 may be connected between the auxiliary output channel ACH and the fifth data line DL5 and may be turned on or off based on the second multiplexer control signal MX2.

R1G1B1 pixels connected to the odd data lines DL1, DL3, and DL5 may be disposed in an odd pixel row L-Odd, and R2G2B2 pixels connected to the even data lines DL2, DL4, and DL6 may be disposed in an even pixel row L-Even.

First, an implementation example of a first image pattern (an image pattern where a black gray level and a white gray level alternate in a unit of one pixel row) connected to the multiplexer switch circuit according to the first example embodiment will be described below with reference to FIGS. 5, 6, 9A, and 9B.

As shown in FIGS. 5 and 6, based on an operation of the multiplexer switch circuit MX-ARY according to the first example embodiment, a data voltage of a black gray level may be charged in an odd pixel row L-Odd for a first time X1, and a data voltage of a white gray level may be charged in an even pixel row L-Even for a second time X2.

To this end, for the first time X1, a first data output channel DCH1 may output a first R data voltage DR1 of a black gray level, a second data output channel DCH2 may output a first G data voltage DG1 of a black gray level, and a third data output channel DCH3 may output a first B data voltage DB1 of a black gray level. For the first time X1, an auxiliary output channel ACH may output a first pre-charge voltage PC1.

As shown in FIGS. 5, 6, and 9A, for the first time X1, the first multiplexer control signal MX1 may be input at an on level, and the second multiplexer control signal MX2 may be input at an off level.

For the first time X1, the first, third, and fifth multiplexer switches M11, M21, and M31 and the first, third, and fifth auxiliary switches A11, A21, and A31 of the multiplexer switch circuit MX-ARY may be turned on based on the first multiplexer control signal MX1 of an on level. On the other hand, the second, fourth, and sixth multiplexer switches M12, M22, and M32 and the second, fourth, and sixth auxiliary switches A12, A22, and A32 of the multiplexer switch circuit MX-ARY may be turned off based on the second multiplexer control signal MX2 of an off level.

For the first time X1, based on an on operation of each of the first, third, and fifth multiplexer switches M11, M21, and M31, the first data output channel DCH1 may be connected to a first data line DL1, the second data output channel DCH2 may be connected to a third data line DL3, and the third data output channel DCH3 may be connected to a fifth data line DL5. As a result, a first R data voltage DR1 of a black gray level BLv may be supplied to the first data line DL1, a first G data voltage DG1 of the black gray level BLv may be supplied to the third data line DL3, and a first B data voltage DB1 of the black gray level BLv may be supplied to the fifth data line DL5. The first, third, and fifth data lines DL1, DL3, and DL5 may be the odd data lines DL-Odd in FIG. 6.

Moreover, for the first time X1, the auxiliary output channel ACH may be connected to the second, fourth, and sixth data lines DL2, DL4, and DL6, based on an on operation of each of the first, third, and fifth auxiliary switches A11, A21, and A31. As a result, a first pre-charge voltage PC1 of a pre-charge level PLv may be supplied to the second, fourth, and sixth data lines DL2, DL4, and DL6 which are the even data lines DL-Even.

Furthermore, for the second time X2, the first data output channel DCH1 may output a second R data voltage DR2 of a white gray level, the second data output channel DCH2 may output a second G data voltage DG2 of a white gray level, and the third data output channel DCH3 may output a second B data voltage DB2 of a white gray level. For the second time X2, the auxiliary output channel ACH may output a second pre-charge voltage PC2.

As shown in FIGS. 5, 6, and 9B, for the second time X2, the first multiplexer control signal MX1 may be input at an off level, and the second multiplexer control signal MX2 may be input at an on level.

For the second time X2, the first, third, and fifth multiplexer switches M11, M21, and M31 and the first, third, and fifth auxiliary switches A11, A21, and A31 of the multiplexer switch circuit MX-ARY may be turned off based on the first multiplexer control signal MX1 of an off level. On the other hand, the second, fourth, and sixth multiplexer switches M12, M22, and M32 and the second, fourth, and sixth auxiliary switches A12, A22, and A32 of the multiplexer switch circuit MX-ARY may be turned on based on the second multiplexer control signal MX2 of an on level.

For the second time X2, based on an on operation of each of the second, fourth, and sixth multiplexer switches M12, M22, and M32, the first data output channel DCH1 may be connected to a second data line DL2, the second data output channel DCH2 may be connected to a fourth data line DL4, and the third data output channel DCH3 may be connected to a sixth data line DL6. As a result, a second R data voltage DR2 of a white gray level WLv may be supplied to the second data line DL2, a second G data voltage DG2 of the white gray level WLv may be supplied to the fourth data line DL4, and a second B data voltage DB2 of the white gray level WLv may be supplied to the sixth data line DL6. The second, fourth, and sixth data lines DL2, DL4, and DL6 may be the even data lines DL-Even in FIG. 6.

Moreover, for the second time X2, the auxiliary output channel ACH may be connected to the first, third, and fifth data lines DL1, DL3, and DL5, based on an on operation of each of the second, fourth, and sixth auxiliary switches A12, A22, and A32. As a result, a second pre-charge voltage PC2 of the pre-charge level PLv may be supplied to the first, third, and fifth data lines DL1, DL3, and DL5 which are the odd data lines DL-Odd.

Next, an implementation example of a second image pattern (an image pattern where a black gray level and a white gray level alternate in a unit of one pixel) connected to the multiplexer switch circuit according to the first example embodiment will be described below with reference to FIGS. 7, 8, 9A, and 9B.

As shown in FIGS. 7 and 8, based on an operation of the multiplexer switch circuit MX-ARY according to the first example embodiment, a data voltage of a black gray level and a data voltage of a white gray level may be alternately charged in an odd pixel row L-Odd in a unit of one pixel for a first time X1, and a data voltage of a white gray level and a data voltage of a black gray level may be alternately charged in an even pixel row L-Even in a unit of one pixel for a second time X2.

To this end, for the first time X1, a first data output channel DCH1 may output a first R data voltage DR1 of a black gray level, a second data output channel DCH2 may output a first G data voltage DG1 of a white gray level, and a third data output channel DCH3 may output a first B data voltage DB1 of a black gray level. For the first time X1, an auxiliary output channel ACH may output a first pre-charge voltage PC1.

As shown in FIGS. 7, 8, and 9A, for the first time X1, the first multiplexer control signal MX1 may be input at an on level, and the second multiplexer control signal MX2 may be input at an off level.

For the first time X1, the first, third, and fifth multiplexer switches M11, M21, and M31 and the first, third, and fifth auxiliary switches A11, A21, and A31 of the multiplexer switch circuit MX-ARY may be turned on by the first multiplexer control signal MX1 of an on level. On the other hand, the second, fourth, and sixth multiplexer switches M12, M22, and M32 and the second, fourth, and sixth auxiliary switches A12, A22, and A32 of the multiplexer switch circuit MX-ARY may be turned off by the second multiplexer control signal MX2 of an off level.

For the first time X1, based on an on operation of each of the first, third, and fifth multiplexer switches M11, M21, and M31, the first data output channel DCH1 may be connected to a first data line DL1, the second data output channel DCH2 may be connected to a third data line DL3, and the third data output channel DCH3 may be connected to a fifth data line DL5. As a result, a first R data voltage DR1 of a black gray level BLv may be supplied to the first data line DL1, a first G data voltage DG1 of the white gray level WLv may be supplied to the third data line DL3, and a first B data voltage DB1 of the black gray level BLv may be supplied to the fifth data line DL5.

Moreover, for the first time X1, the auxiliary output channel ACH may be connected to the second, fourth, and sixth data lines DL2, DL4, and DL6, based on an on operation of each of the first, third, and fifth auxiliary switches A11, A21, and A31. As a result, a first pre-charge voltage PC1 of a pre-charge level PLv may be supplied to the second, fourth, and sixth data lines DL2, DL4, and DL6.

Furthermore, for the second time X2, the first data output channel DCH1 may output a second R data voltage DR2 of a white gray level, the second data output channel DCH2 may output a second G data voltage DG2 of a black gray level, and the third data output channel DCH3 may output a second B data voltage DB2 of a white gray level. For the second time X2, the auxiliary output channel ACH may output a second pre-charge voltage PC2.

As shown in FIGS. 7, 8, and 9B, for the second time X2, the first multiplexer control signal MX1 may be input at an off level, and the second multiplexer control signal MX2 may be input at an on level.

For the second time X2, the first, third, and fifth multiplexer switches M11, M21, and M31 and the first, third, and fifth auxiliary switches A11, A21, and A31 of the multiplexer switch circuit MX-ARY may be turned off by the first multiplexer control signal MX1 of an off level. On the other hand, the second, fourth, and sixth multiplexer switches M12, M22, and M32 and the second, fourth, and sixth auxiliary switches A12, A22, and A32 of the multiplexer switch circuit MX-ARY may be turned on by the second multiplexer control signal MX2 of an on level.

For the second time X2, based on an on operation of each of the second, fourth, and sixth multiplexer switches M12, M22, and M32, the first data output channel DCH1 may be connected to a second data line DL2, the second data output channel DCH2 may be connected to a fourth data line DL4, and the third data output channel DCH3 may be connected to a sixth data line DL6. As a result, a second R data voltage DR2 of a white gray level WLv may be supplied to the second data line DL2, a second G data voltage DG2 of the black gray level BLv may be supplied to the fourth data line DL4, and a second B data voltage DB2 of the white gray level WLv may be supplied to the sixth data line DL6.

Moreover, for the second time X2, the auxiliary output channel ACH may be connected to the first, third, and fifth data lines DL1, DL3, and DL5, based on an on operation of each of the second, fourth, and sixth auxiliary switches A12, A22, and A32. As a result, a second pre-charge voltage PC2 of the pre-charge level PLv may be supplied to the first, third, and fifth data lines DL1, DL3, and DL5 which are the odd data lines DL-Odd.

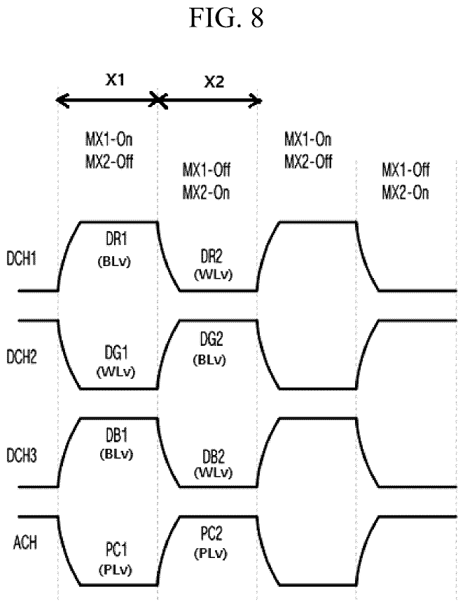

FIG. 10 is a diagram illustrating an example connection configuration of a pixel applied to a display device according to an example embodiment of the present disclosure.

As shown in FIG. 10, a pixel SP (n) disposed in an n^{th} pixel row Ln may be implemented with a pixel circuit which includes a light emitting element OLED, a driving transistor DT, a plurality of switch transistors (for example, first to seventh switch transistors) T1 to T7, and a capacitor Cst.

The driving transistor DT, the switch transistors T1 to T7, and the capacitor Cst may control a driving current flowing in the light emitting element OLED to drive the light emitting element OLED. Each of the driving transistor DT and the switch transistors T1 to T7 may include a first electrode, a second electrode, and a gate electrode. One of the first electrode and the second electrode may be a source electrode, and the other of the first electrode and the second electrode may be a drain electrode.

Each of the second to sixth transistors T2 to T6 and the driving transistor DT may be implemented as a PMOS type including a semiconductor layer having LTPS, which is good in a response characteristic. On the other hand, the first and seventh transistors T1 and T7 connected to a gate electrode of the driving transistor DT may be implemented as an NMOS type including an oxide semiconductor layer, which is good in an off characteristic.

An on level voltage of the PMOS-type transistor may be a gate low voltage, and an off level voltage may be a gate high voltage. On the other hand, an on level voltage of the NMOS-type transistor may be a gate high voltage, and an off level voltage may be a gate low voltage.

The light emitting element OLED may include an anode electrode (or a pixel electrode), a cathode electrode (or a common electrode), and an organic compound layer (configured with a common layer and an emission layer) disposed therebetween. The anode electrode of the light emitting element OLED may be connected to a fourth node N4, and the cathode electrode of the light emitting element OLED may be connected to a second source voltage ELVSS.

The driving transistor DT may include a gate electrode connected to the first node N1, a source electrode connected to a second node N2, and a drain electrode connected to a third node N3. The driving transistor DT may generate the driving current based on a voltage of the first node N1 (or a data voltage stored in the capacitor Cst) and may apply the driving current to the light emitting element OLED.

The first switch transistor T1 may include a gate electrode receiving a first scan signal SCAN1 through a first scan line SL1, a drain electrode connected to the third node N3, and a source electrode connected to the first node N1. The first switch transistor T1 may be turned on in response to the first scan signal SCAN1 and may short-circuit the gate electrode and the drain electrode of the driving transistor DT with each other. Accordingly, the driving transistor DT may operate like a diode while the first switch transistor T1 is turned on.

The second switch transistor T2 may include a gate electrode receiving a second scan signal SCAN2 through a second scan line SL2, a source electrode connected to a data line (or receiving a data voltage Vdata), and a drain electrode connected to the second node N2. The second switch transistor T2 may be turned on in response to the second scan signal SCAN2 and may transfer the data voltage Vdata to the second node N2.

The capacitor Cst may be connected between the first node N1 and an input terminal of the first source voltage ELVDD. The capacitor Cst may hold a voltage of the first node N1.

The third and fourth switch transistors T3 and T4 may be connected between the first source voltage ELVDD and the light emitting diode OLED and may form a current movement path through which the driving current generated by the driving transistor DT moves.

The third switch transistor T3 may include a source electrode connected to the input terminal of the first source voltage ELVDD, a drain electrode connected to the second node N2, and a gate electrode configured to receive an emission control signal EM through an emission control line EL. The fourth switch transistor T4 may include a source electrode connected to the third node N3, a drain electrode connected to the fourth node N4, and a gate electrode configured to receive the emission control signal EM through the emission control line EL.

The third and fourth switch transistors T3 and T4 may be turned on in response to the emission control signal EM. While the third and fourth switch transistors T3 and T4 are turned on, the light emitting element OLED may receive the driving current from the driving transistor DT and may emit light with brightness corresponding to the driving current.

The fifth switch transistor T5 may include a source electrode connected to an input terminal of an OBS voltage Vobs, a drain electrode connected to the second node N2, and a gate electrode configured to receive a third scan signal SCAN3 through a third scan line SL3. The fifth switch transistor T5 may be turned on based on the third scan signal SCAN3 and may apply the OBS voltage Vobs to the second node N2.

The sixth switch transistor T6 may include a source electrode connected to an input terminal of an anode reset voltage Var, a drain electrode connected to the fourth node N4, and a gate electrode configured to receive the third scan signal SCAN3 through the third scan line SL3. The sixth switch transistor T6 may be turned on based on the third scan signal SCAN3 and may transfer the anode reset voltage Var to the fourth node N4.

The seventh switch transistor T7 may include a source electrode connected to an input terminal of an initialization voltage Vini, a drain electrode connected to the first node N1, and a gate electrode configured to receive a fourth scan signal SCAN4 through a fourth scan line SLA. The seventh switch transistor T7 may be turned on based on the fourth scan signal SCAN4 and may apply the initialization voltage Vini to the first node N1.

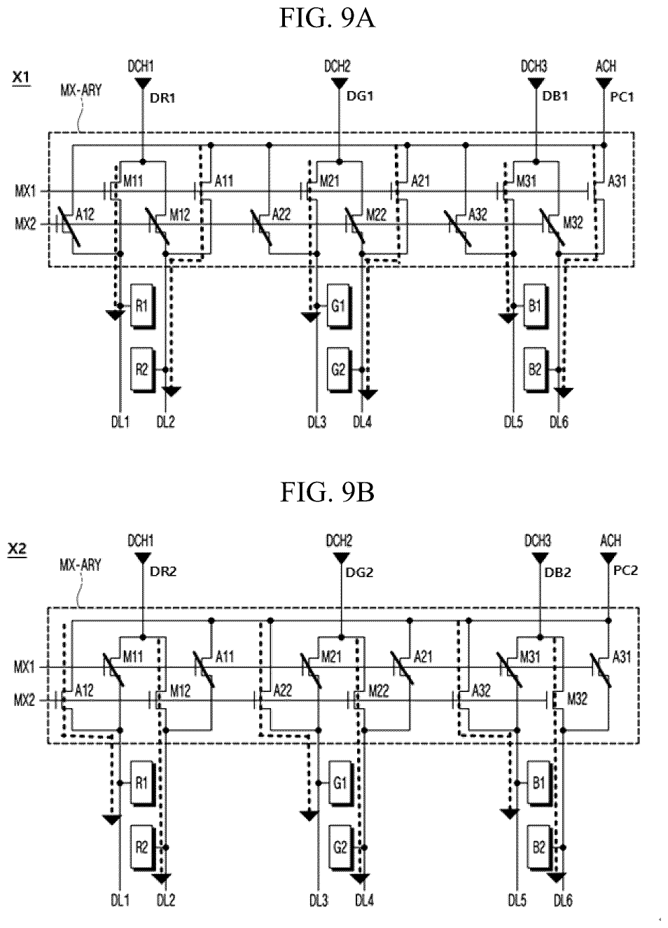

FIG. 11 is a diagram illustrating a driving waveform of a pixel SP (n) in a refresh frame.

As shown in FIG. 11, a first OBS period Tobs1, an initialization period Ti, a programming period Ts, a second OBS period Tobs2, and an emission period Te may be serially arranged in time in the refresh frame.

The second scan signal SCAN2 may define the programming period Ts where a data voltage Vdata is supplied. The programming period Ts may be an on level (Lon) period of a second scan signal SCAN2.

The third scan signal SCAN3 may define a first OBS period Tobs1 preceding the programming period Ts and a second OBS period Tobs2 succeeding the programming period Ts and preceding the emission period Te. The first OBS period Tobs1 and the second OBS period Tobs2 may each be an on level (Lon) period of the third scan signal SCAN3.

The fourth scan signal SCAN4 may define an initialization period Ti which is arranged between the first OBS period Tobs1 and the programming period Ts. The initialization period Ti may be an on level (Lon) period of the fourth scan signal SCAN4.

The emission control signal EM may define an emission period Te succeeding the second OBS period Tobs2. The emission period Te may be an on level (Lon) period of the emission control signal EM.

As shown in FIGS. 10 and 11, in the first OBS period Tobs1, in response to the third scan signal SCAN3 at an on level Lon, the fifth and sixth switch transistors T5 and T6 may be turned on, and the other switch transistors T1 to T4 and T7 may be turned off.

In the first OBS period Tobs1, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state. Thus, a hysteresis characteristic of the driving transistor DT may be recovered prior to data programming.

In the first OBS period Tobs1, as the sixth switch transistor T6 is turned on, the anode reset voltage Var may be applied to the fourth node N4. Based on the anode reset voltage Var, residual electric charges charged in a parasitic capacitor formed between the anode electrode and the cathode electrode of the light emitting element OLED may be reset.

As shown in FIGS. 10 and 11, in the initialization period Ti, in response to the first scan signal SCAN1 and the fourth scan signal SCAN4 at an on level Lon, the first and seventh switch transistors T1 and T7 may be turned on, and the other switch transistors T2 to T6 may be turned off. As the seventh switch transistor T7 is turned on, the first node N1 may be initialized into the initialization voltage Vini, and as the first switch transistor T1 is turned on, the driving transistor DT may operate like a diode.

As shown in FIGS. 10 and 11, in the programming period Ts, as the first and second switch transistors T1 and T2 are turned on, a threshold voltage sampling operation and a data programming operation may be sequentially or simultaneously performed.

In the programming period Ts, an electric potential of a data line DL may be converted from a pre-charge voltage Vpc, which is previously charged, into a data voltage Vdata. Because a voltage difference between the pre-charge voltage Vpc and the data voltage Vdata is small, a data slew of the data line DL may be improved.

In the programming period Ts, the data voltage Vdata charged in the data line DL may be applied to the second node N2 through the second switch transistor T2. The data voltage Vdata may be applied to the third node N3 through the driving transistor DT, and then, may be applied to the first node N1 through the first switch transistor T1. The driving transistor DT may operate like a diode in a state where the first switch transistor T1 is turned on, and an electric potential at the gate electrode of the driving transistor DT connected to the first node N1 may be programmed to be “Vdata−|Vth|”. A threshold voltage Vth may be sampled and reflected in a programmed electric potential at the gate electrode of the driving transistor DT.

As shown in FIGS. 10 and 11, in the second OBS period Tobs2, in response to the third scan signal SCAN3 at an on level Lon, the fifth and sixth switch transistors T5 and T6 may be turned on, and the other switch transistors T1 to T4 and T7 may be turned off.

In the second OBS period Tobs2, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state. Thus, a hysteresis characteristic of the driving transistor DT may be re-recovered prior to the emission of light.

In the second OBS period Tobs2, as the sixth switch transistor T6 is turned on, the anode reset voltage Var may be applied to the fourth node N4. Thus, residual electric charges charged in a parasitic capacitor of the light emitting element OLED may be re-reset.

As shown in FIGS. 10 and 11, in the emission period Te, in response to the emission control signal EM at an on level Lon, the third and fourth switch transistors T3 and T4 may be turned on, and the other switch transistors T1, T2, T5, T6, and T7 may be turned off.

In the emission period Te, a driving current supplied from the driving transistor DT to the light emitting element OLED may be based on Vgs of the driving transistor DT set in the programming period Ts. The driving current may be irrelevant to a threshold voltage of the driving transistor DT and may be associated with the data voltage Vdata.

As described above, in the refresh frame, the data line DL may be previously connected to an auxiliary output channel before being connected to a data output channel of a source driver, and may thus be supplied with the pre-charge voltage Vpc through the auxiliary output channel. The data line DL may be previously charged with the pre-charge voltage Vpc prior to the data voltage Vdata, and thus, a data slew of the data line DL may be improved.

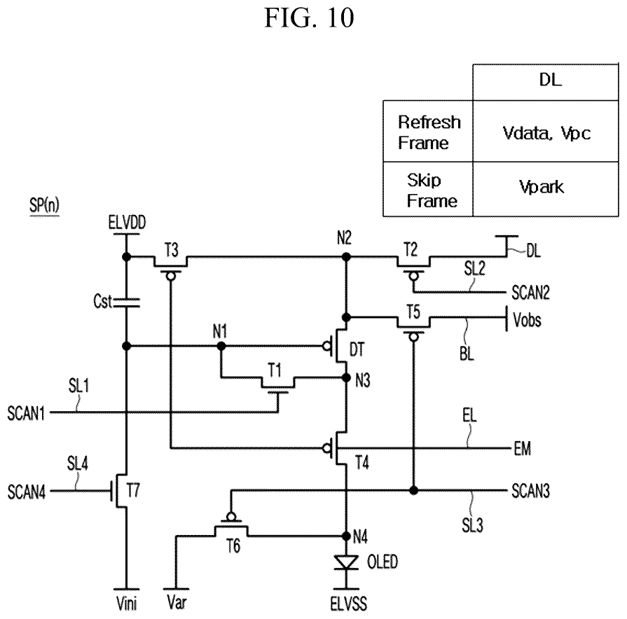

FIG. 12 is a diagram illustrating a driving waveform of the pixel SP (n) in a skip frame.

As shown in FIG. 12, a third OBS period Tobs3, a fourth OBS period Tobs4, and an emission period Te may be serially arranged in time in the skip frame.

The emission control signal EM may define the emission period Te of the skip frame. The emission period Te may be an on level (Lon) period of the emission control signal EM. The on level (Lon) period of the emission control signal EM in the skip frame may be substantially the same as the refresh frame.

The third scan signal SCAN3 may define the third OBS period Tobs3 and the fourth OBS period Tobs4 which are sequentially arranged before the emission period Te in the skip frame. In the skip frame, the third OBS period Tobs3 and the fourth OBS period Tobs4 may each be an on level (Lon) period of the third scan signal SCAN3.

Furthermore, the initialization period and the programming period may be skipped and not implemented in the skip frame. Also, the fourth OBS period Tobs4 may be skipped in the skip frame.

As shown in FIGS. 10 and 12, a hysteresis characteristic of the driving transistor DT may be re-improved in the third OBS period Tobs3 and the fourth OBS period Tobs4. Thus, a hysteresis characteristic deviation between the skip frame and the refresh frame may be considerably reduced.

The first and second OBS periods Tobs1 and Tobs2 of the refresh frame may be included in an off level (Loff) period of the emission control signal EM. Moreover, the third and fourth OBS periods Tobs3 and Tobs4 of the skip frame may be included in the off level (Loff) period of the emission control signal EM.

A length of the off level (Loff) period of the emission control signal EM may be equal in the refresh frame as in the skip frame. Thus, a length of an emission maintenance time may be equal in the refresh frame as in the skip frame.

Furthermore, in the skip frame, the data line DL may be connected to the auxiliary output channel of the source driver and may be further supplied with a line stabilization voltage Vpark of a direct current (DC) level through the auxiliary output channel. The line stabilization voltage Vpark may fix an electric potential of the data line DL in the skip frame, and may thus prevent or suppress a problem where a voltage charged in a pixel is distorted due to an electric potential variation of the data line DL.

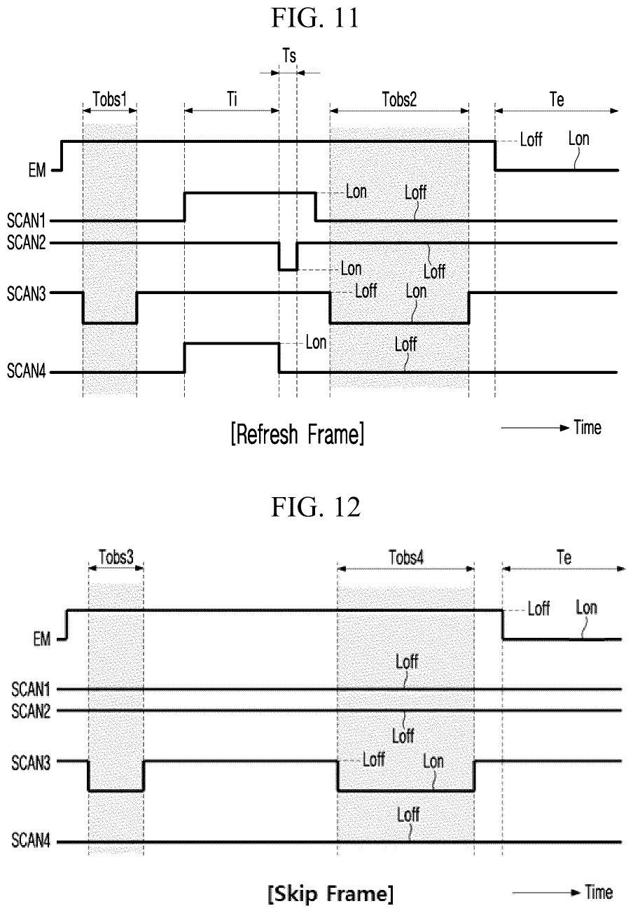

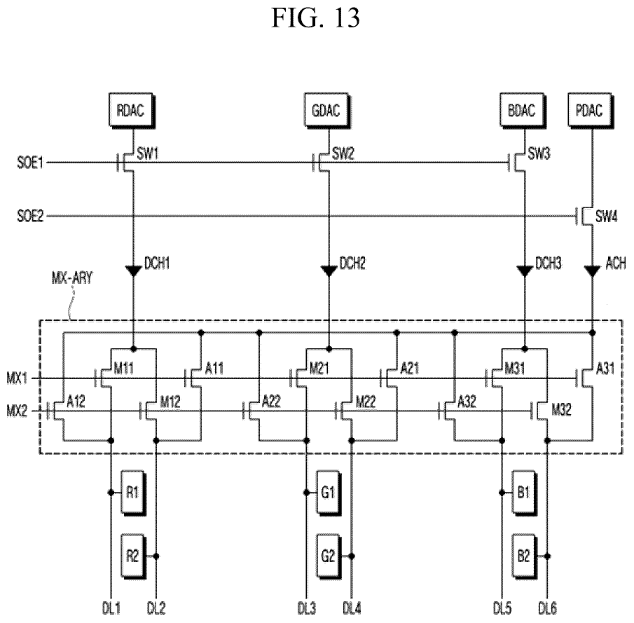

FIG. 13 is a diagram illustrating some elements of a multiplexer switch circuit and a source driver connected thereto according to a first example embodiment. FIG. 14 is a diagram illustrating a data output and an auxiliary output of a source driver during a refresh frame and a skip frame.

As shown in FIGS. 13 and 14, the source driver may include a plurality of digital-to-analog converters RDAC, GDAC, BDAC, and PDAC and first to fourth output control switches SW1 to SW4.

The RDAC may generate and output first and second R data voltages DR1 and DR2.

The first output control switch SW1 may be connected between an output of the RDAC and a first data output channel DCH1 and may be turned on or off based on a first source output control signal SOE1.

The GDAC may generate and output first and second G data voltages DG1 and DG2.

The second output control switch SW2 may be connected between an output of the GDAC and a second data output channel DCH2 and may be turned on or off based on the first source output control signal SOE1.

The BDAC may generate and output first and second B data voltages DB1 and DB2.

The third output control switch SW3 may be connected between an output of the BDAC and a third data output channel DCH3 and may be turned on or off based on the first source output control signal SOE1.

The PDAC may generate and output first and second pre-charge voltages PC1 and PC2 and the line stabilization voltage Vpark.

The first and second pre-charge voltages PC1 and PC2 may each be a voltage which varies over time within a predetermined pre-charge voltage range. An image gray level implemented in the same pixel and a target data voltage for expressing the image gray level may vary over time. A data slew may be defined as a speed at which an electric potential of a data line follows a target level of a data voltage. Therefore, when a target data voltage varies over time, the first and second pre-charge voltages PC1 and PC2 may follow the target data voltage to vary over time, so as to increase a data slew. Here, the pre-charge voltage range may be arranged between a data output upper limit and a data output lower limit of the source driver. That is, the pre-charge voltage range may be greater than a minimum data voltage and less than a maximum data voltage.

The line stabilization voltage Vpark may be fixed to be a voltage within the pre-charge voltage range. A level of the line stabilization voltage Vpark may be fixed without varying over time. The line stabilization voltage Vpark may have a DC level.

The fourth output control switch SW4 may be connected between an output of the PDAC and an auxiliary output channel ACH and may be turned on or off based on a second source output control signal SOE2.

The first source output control signal SOE1 and the second source output control signal SOE2 may maintain an on state in the refresh frame. The first and second multiplexer control signals MX1 and MX2 may be alternately turned on or off in the refresh frame.

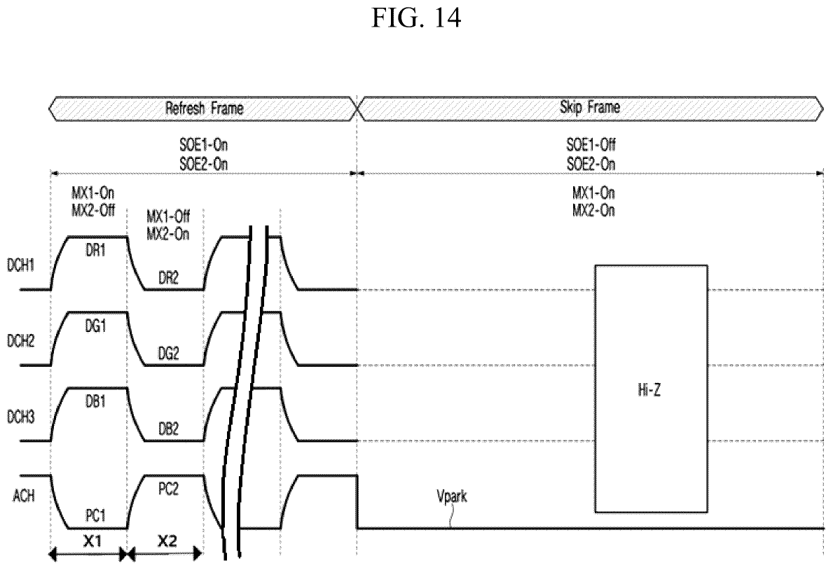

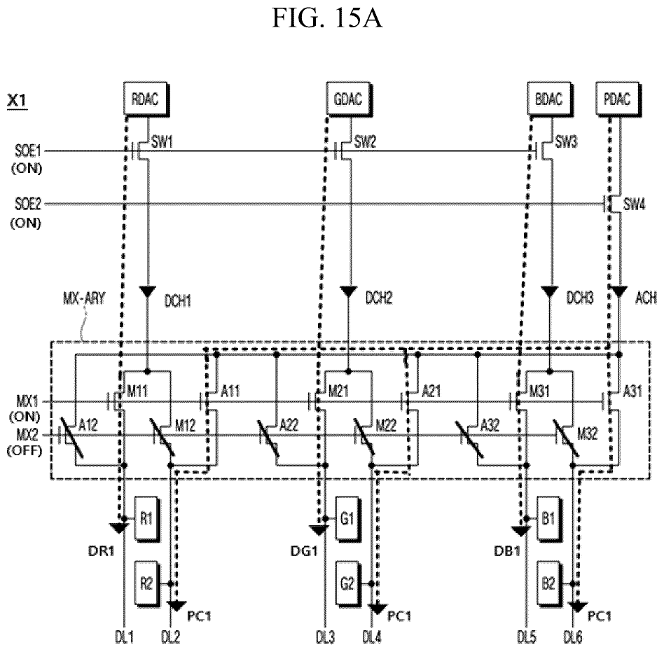

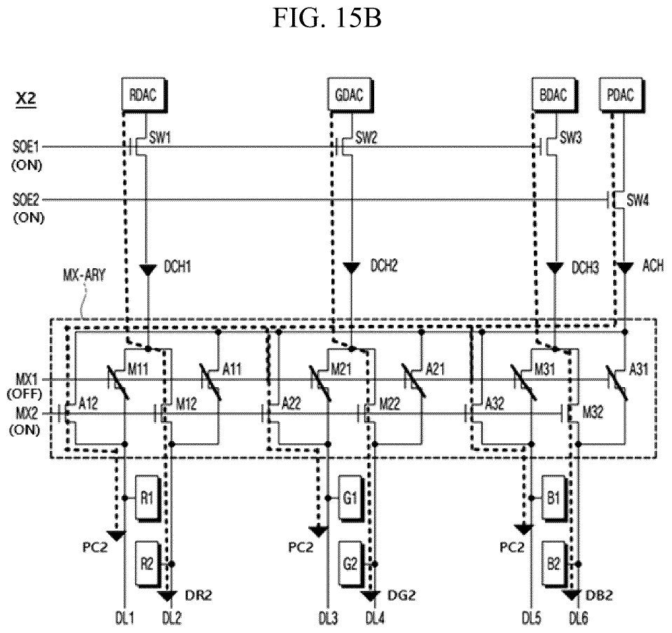

FIG. 15A is a diagram illustrating an operation state of a multiplexer switch circuit MX-ARY implemented at a first time X1 of a refresh frame.

As shown in FIG. 14 and FIG. 15A, at the first time X1 of the refresh frame, a first multiplexer control signal MX1 may be turned on, and a second multiplexer control signal MX2 may be turned off.

At the first time X1 of the refresh frame, a first R data voltage DR1 output from an RDAC may be supplied to a first data line DL1 through a first output control switch SW1 and a first multiplexer switch M11.

At the first time X1 of the refresh frame, a first G data voltage DG1 output from a GDAC may be supplied to a third data line DL3 through a second output control switch SW2 and a third multiplexer switch M21.

At the first time X1 of the refresh frame, a first B data voltage DB1 output from a BDAC may be supplied to a fifth data line DL5 through a third output control switch SW3 and a fifth multiplexer switch M31.

At the first time X1 of the refresh frame, a first pre-charge voltage PC1 output from a PDAC may be supplied to second, fourth, and sixth data lines DL2, DL4, and DL6 through a fourth output control switch SW4 and first, third, and fifth auxiliary switches A11, A21, and A31.

FIG. 15B is a diagram illustrating an operation state of the multiplexer switch circuit MX-ARY implemented at a second time X2 of the refresh frame.

As shown in FIG. 14 and FIG. 15B, at the second time X2 of the refresh frame, a first multiplexer control signal MX1 may be turned off, and a second multiplexer control signal MX2 may be turned on.

At the first time X2 of the refresh frame, the second R data voltage DR2 output from the RDAC may be supplied to a second data line DL2 through the first output control switch SW1 and a second multiplexer switch M12.

At the second time X2 of the refresh frame, the second G data voltage DG2 output from the GDAC may be supplied to a fourth data line DL4 through the second output control switch SW2 and a fourth multiplexer switch M22.

At the second time X2 of the refresh frame, the second B data voltage DB2 output from the BDAC may be supplied to a sixth data line DL6 through the third output control switch SW3 and a sixth multiplexer switch M32.

At the second time X2 of the refresh frame, a second pre-charge voltage PC2 output from the PDAC may be supplied to first, third, and fifth data lines DL1, DL3, and DL5 through the fourth output control switch SW4 and second, fourth, and sixth auxiliary switches A12, A22, and A32.

FIG. 15C is a diagram illustrating an operation state of the multiplexer switch circuit MX-ARY implemented in a skip frame.

As shown in FIG. 14 and FIG. 15C, in the skip frame, the first source output control signal SOE1 may be turned off, and the second source output control signal SOE2 may be turned on. Based on an off operation of the first source output control signal SOE1, data output channels DCH1, DCH2, and DCH3 may be put in a floating state Hi-Z in the skip frame. Based on an on operation of the second source output control signal SOE2, the fourth output control switch SW4 may maintain an on state in the skip frame.

In the skip frame, the PDAC may output a line stabilization voltage Vpark. The line stabilization voltage Vpark output from the PDAC may be supplied to the first to sixth data lines DL1 to DL6 through the fourth output control switch SW4 and the first to sixth auxiliary switches A11 to A32 and may prevent or reduce a change in electric potential of a data line caused by a peripheral environment.

Main elements for generating the pre-charge voltages PC1 and PC2 and the line stabilization voltage Vpark and supply paths thereof may be equal to one another. Thus, a circuit may be simplified, and power consumption may be reduced.

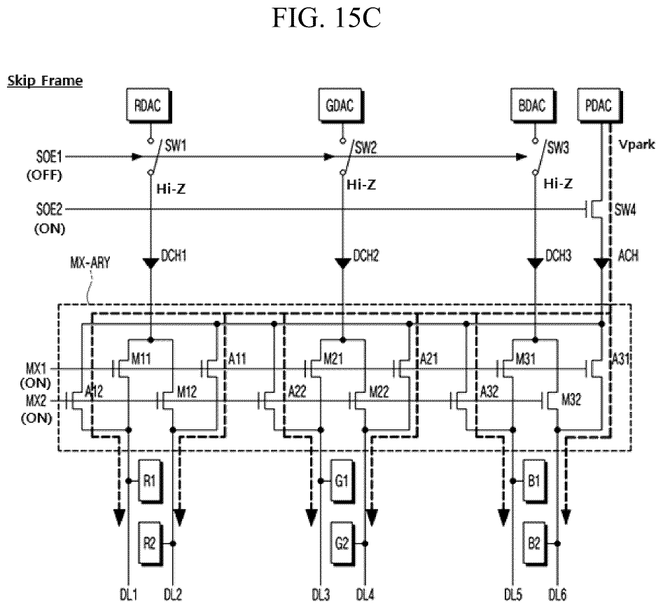

FIG. 16 is a diagram illustrating another example connection configuration of a pixel applied to a display device according to an example embodiment of the present disclosure.

In the example pixel circuit of FIG. 16, the other elements except a connection configuration of a fifth switch transistor T5 may be the same as the pixel circuit of FIG. 10.

As shown in FIG. 16, a source electrode of the fifth switch transistor T5 may be directly connected to a data line DL and may receive an OBS voltage Vobs through the data line DL.

The data line DL may be connected to a data output channel and an auxiliary output channel of a source driver through the multiplexer switch circuit MX-ARY described above.

In a refresh frame, as described above, the source driver may output a data voltage Vdata through the data output channel and may output a pre-charge voltage Vpc through the auxiliary output channel. Also, in the skip frame, the source driver may output the pre-charge voltage Vpc through the auxiliary output channel.

The source driver may float the data output channel during an OBS period of each of the refresh frame and the skip frame and may output, through the auxiliary output channel, the OBS voltage Vobs which is to be supplied to the data line DL.

The multiplexer switch circuit MX-ARY may connect the data line DL to the auxiliary output channel in the OBS period(s). As a result, in the OBS period(s), the OBS voltage may be applied to a second node connected to a source electrode of a driving transistor DT in synchronization with a light emitting element OLED included in the pixel SP (n) being initialized to an anode reset voltage Var.

As described above, the source driver for driving the pixel circuit of FIG. 16 may further output the OBS voltage Vobs through the auxiliary output channel in the refresh frame and the skip frame, and may thus additionally contribute to circuit simplification.

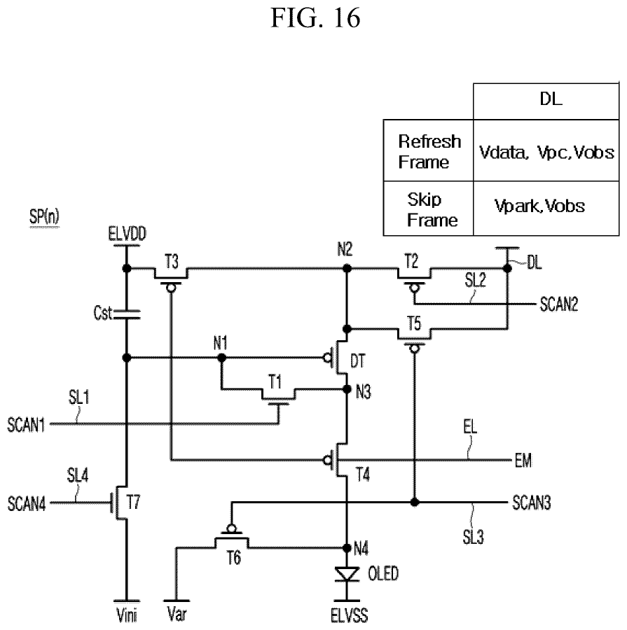

According to the present example embodiment, as shown in FIG. 17, the pre-charge voltage Vpc and the OBS voltage Vobs may be charged in one data line through one auxiliary output channel at different times during the refresh frame.

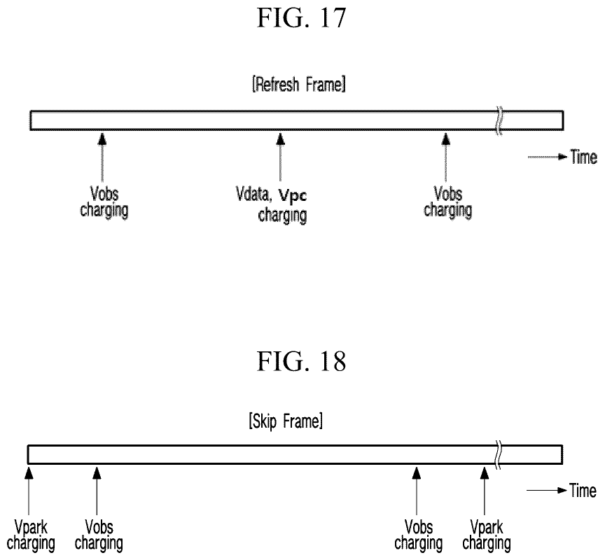

According to the present example embodiment, as shown in FIG. 18, the line stabilization voltage Vpark and the OBS voltage Vobs may be charged in one data line through one auxiliary output channel at different times during the skip frame.

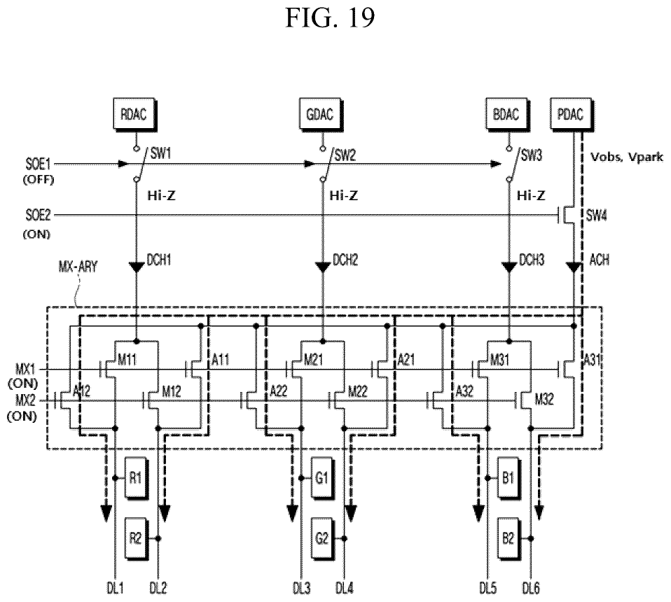

FIG. 19 is a diagram illustrating an operation state of a multiplexer switch circuit MX-ARY for selectively outputting a line stabilization voltage Vpark and an OBS voltage Vobs in a skip frame.

As shown in FIG. 19, in a skip frame, a first source output control signal SOE1 may be turned off, and a second source output control signal SOE2 may be turned on. Based on an off operation of the first source output control signal SOE1, data output channels DCH1, DCH2, and DCH3 may be put in a floating state Hi-Z in the skip frame (see, e.g., FIG. 14). Based on an on operation of the second source output control signal SOE2, a fourth output control switch SW4 may maintain an on state in the skip frame.

In the skip frame, a PDAC may alternately output a line stabilization voltage Vpark and an OBS voltage Vobs. The line stabilization voltage Vpark output from the PDAC may be supplied to first to sixth data lines DL1 to DL6 through the fourth output control switch SW4 and first to sixth auxiliary switches A11 to A32 and may prevent or reduce a change in electric potential of a data line caused by a peripheral environment.

The OBS voltage Vobs output from the PDAC may be supplied to the first to sixth data lines DL1 to DL6 through the fourth output control switch SW4 and the first to sixth auxiliary switches A11 to A32, and may thus contribute to improving a hysteresis characteristic of the pixels.

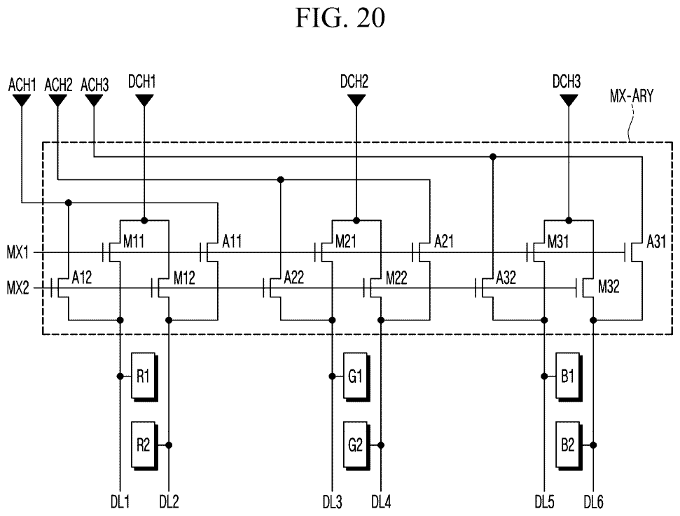

FIG. 20 is a diagram illustrating a connection configuration of a multiplexer switch circuit MX-ARY according to a second example embodiment for improving a data slew of a data line.

Comparing with the multiplexer switch circuit MX-ARY according to the first example embodiment described above with reference to FIGS. 5 and 7, the multiplexer switch circuit MX-ARY of FIG. 20 may have the following differences.

According to the multiplexer switch circuit MX-ARY of FIGS. 5 and 7, the data output channels DCH1, DCH2, and DCH3 may be independently provided for each of R, G, and B pixels, and the auxiliary output channel ACH may be commonly provided to the R, G, and B pixels.

According to the multiplexer switch circuit MX-ARY of FIG. 20, data output channels DCH1, DCH2, and DCH3 may be independently provided for each of R, G, and B pixels, and auxiliary output channels (for example first to third auxiliary output channels) ACH1, ACH2, and ACH3 may also be independently provided for each of the R, G, and B pixels.

The first auxiliary output channel ACH1 may be selectively connected to only data lines DL1 and DL2 connected to R pixels R1 and R2. An output of the first auxiliary output channel ACH1 may be supplied to a second data line DL2 through a first auxiliary switch A11 and may be supplied to a first data line DL1 through a second auxiliary switch A12.

The second auxiliary output channel ACH2 may be selectively connected to only data lines DL3 and DL4 connected to G pixels G1 and G2. An output of the second auxiliary output channel ACH2 may be supplied to a fourth data line DL4 through a third auxiliary switch A21 and may be supplied to a third data line DL3 through a fourth auxiliary switch A22.

The third auxiliary output channel ACH3 may be selectively connected to only data lines DL5 and DL6 connected to B pixels B1 and B2. An output of the third auxiliary output channel ACH3 may be supplied to a sixth data line DL6 through a fifth auxiliary switch A31 and may be supplied to a fifth data line DL5 through a sixth auxiliary switch A32.

The above embodiments of the present disclosure may realize the following example effects.

The above embodiments of present disclosure may supply a pre-charge voltage to a display panel through a connection configuration between a source driver and a multiplexer switch circuit and may thus improve a data slew with a low power consumption to enhance image quality.

The above embodiments of the present disclosure may unify a main element for generating a line stabilization voltage and/or an OBS voltage in addition to the pre-charge voltage and a supply path thereof, and may thus simplify a circuit for driving the display panel and implement low power consumption.

The effects according to the present disclosure are not limited to the above examples, and various additional effects may be achieved from the present disclosure.

It will be apparent to those skilled in the art that the present disclosure is not limited by the above-described example embodiments and the accompanying drawings, and that various substitutions, modifications, and variations can be made in the present disclosure without departing from the spirit or scope of the disclosures. Therefore, the above example embodiments of the present disclosure are provided for illustrative purposes and are not intended to limit the scope or technical concept of the present disclosure.

What is claimed is:

1. A display device, comprising:
a display panel including:
a first pixel in a first pixel row and connected to a first data line; and
a second pixel adjacent to the first pixel, in a second pixel row, and connected to a second data line;
a source driver including:
a data output channel configured to output a first data voltage to be supplied to the first data line in a first time period during a refresh frame and to output a second data voltage to be supplied to the second data line in a second time period following the first time period during the refresh frame; and
an auxiliary output channel configured to output a first pre-charge voltage to be supplied to the second data line in the first time period and to output a second pre-charge voltage to be supplied to the first data line in the second time period; and
a multiplexer switch circuit configured to:
connect the data output channel to the first data line and connect the auxiliary output channel to the second data line in the first time period; and
connect the data output channel to the second data line and connect the auxiliary output channel to the first data line in the second time period.

2. The display device of claim 1, wherein the multiplexer switch circuit comprises:
a first multiplexer switch connected between the data output channel and the first data line and configured to be turned on or off based on a first multiplexer control signal;
a first auxiliary switch connected between the auxiliary output channel and the second data line and configured to be turned on or off based on the first multiplexer control signal;
a second multiplexer switch connected between the data output channel and the second data line and configured to be turned on or off based on a second multiplexer control signal; and
a second auxiliary switch connected between the auxiliary output channel and the first data line and configured to be turned on or off based on the second multiplexer control signal,
wherein, in the first time period, the first multiplexer control signal is at an on level, and the second multiplexer control signal is at an off level, and
wherein, in the second time period, the first multiplexer control signal is at the off level, and the second multiplexer control signal is at the on level.

3. The display device of claim 1, wherein:
the first pre-charge voltage and the second pre-charge voltage vary over time within a predetermined pre-charge voltage range; and
the predetermined pre-charge voltage range has a low end that is greater than a minimum data voltage output from the source driver and has a high end that is less than a maximum data voltage output from the source driver.

4. The display device of claim 3, wherein, during at least one skip frame preceding or following the refresh frame:
the source driver is configured to float the data output channel and to output, through the auxiliary output channel, a line stabilization voltage to be supplied to the first data line and the second data line; and
the multiplexer switch circuit is configured to simultaneously connect the first data line and the second data line to the auxiliary output channel.

5. The display device of claim 4, wherein:
the line stabilization voltage is a voltage within the predetermined pre-charge voltage range; and
an electric potential of each of the first data line and the second data line is configured to be maintained at the line stabilization voltage during the at least one skip frame.

6. The display device of claim 1, wherein, during an on-bias stress (OBS) period in the refresh frame and outside the first time period and the second time period:
the source driver is configured to float the data output channel and to output, through the auxiliary output channel, an OBS voltage to be supplied commonly to the first data line and the second data line;
the multiplexer switch circuit is configured to simultaneously connect the first data line and the second data line to the auxiliary output channel in the OBS period; and
the OBS voltage is applied to a driving element included in each of the first pixel and the second pixel in synchronization with a light emitting element included in each of the first pixel and the second pixel being initialized to an anode reset voltage.

7. The display device of claim 6, wherein, during at least one skip frame preceding or following the refresh frame:
the source driver is configured to float the data output channel and to output, through the auxiliary output channel, a line stabilization voltage to be supplied to the first data line and the second data line; and
the multiplexer switch circuit is configured to simultaneously connect the first data line and the second data line to the auxiliary output channel.

8. The display device of claim 7, wherein:
the first pre-charge voltage and the second pre-charge voltage are within a predetermined pre-charge voltage range;
the line stabilization voltage is a voltage within the predetermined pre-charge voltage range; and
an electric potential of each of the first data line and the second data line is configured to be maintained at the line stabilization voltage during the at least one skip frame.

9. A method of driving a display device including a display panel having a first pixel in a first pixel row and connected to a first data line and having a second pixel adjacent to the first pixel, in a second pixel row, and connected to a second data line, the method comprising:
in a first time period during a refresh frame, providing a first data voltage to the first data line through a data output channel of a source driver and providing a first pre-charge voltage to the second data line through an auxiliary output channel of the source driver;
in a second time period following the first time period during the refresh frame, providing a second data voltage to the second data line through the data output channel and providing a second pre-charge voltage to the first data line through the auxiliary output channel;
connecting the data output channel to the first data line and connecting the auxiliary output channel to the second data line in the first time period during the refresh frame; and
connecting the data output channel to the second data line and connecting the auxiliary output channel to the first data line in the second time period during the refresh frame.

10. The method of claim 9, wherein:
the first pre-charge voltage and the second pre-charge voltage vary over time within a predetermined pre-charge voltage range; and
the predetermined pre-charge voltage range has a low end that is greater than a minimum data voltage output from the source driver and has a high end that is less than a maximum data voltage output from the source driver.

11. The method of claim 10, further comprising, during at least one skip frame following the refresh frame:
floating the data output channel of the source driver;
providing, through the auxiliary output channel of the source driver, a line stabilization voltage to the first data line and the second data line; and
connecting the auxiliary output channel simultaneously to the first data line and the second data line.

12. The method of claim 11, wherein:
the line stabilization voltage is a fixed voltage within the predetermined pre-charge voltage range; and
an electric potential of each of the first data line and the second data line is configured to be maintained at the line stabilization voltage during the at least one skip frame.

13. The method of claim 9, further comprising:
floating the data output channel of the source driver during an on-bias stress (OBS) period in the refresh frame, the OBS period being outside the first time period and the second time period of the refresh frame;
outputting an OBS voltage through the auxiliary output channel of the source driver during the OBS period of the refresh frame; and
connecting the auxiliary output channel simultaneously to the first data line and the second data line to provide the OBS voltage to the first data line and the second data line in the OBS period,
wherein, in the OBS period, the OBS voltage is applied to a source electrode of a driving element included in each of the first pixel and the second pixel in synchronization with a light emitting element included in each of the first pixel and the second pixel being initialized to an anode reset voltage.

14. The method of claim 13, further comprising, in at least one skip frame preceding or following the refresh frame:
floating the data output channel of the source driver;
outputting, through the auxiliary output channel of the source driver, a line stabilization voltage; and
connecting the auxiliary output channel simultaneously to the first data line and the second data line to provide the line stabilization voltage to first data line and the second data line.

15. A display device, comprising:
a source driver having a first data output channel and a first auxiliary output channel, the source driver being configured to:
output a first data voltage via the first data output channel and a first pre-charge voltage via the first auxiliary output channel in a first time period during a refresh frame; and
output a second data voltage via the first data output channel and a second pre-charge voltage via the first auxiliary output channel in a second time period following the first time period during the refresh frame; and
a display panel including a plurality of pixels, including:
a first pixel in a first column in an odd pixel row and connected to a first data line configured to receive the first data voltage in the first time period and the second pre-charge voltage in the second time period; and
a second pixel in the first column in an even pixel row and connected to a second data line configured to receive the first pre-charge voltage in the first time period and the second data voltage in the second time period.

16. The display device of claim 15, further comprising a multiplexer circuit configured to:
connect the first data output channel to the first data line and connect the first auxiliary output channel to the second data line in the first time period during the refresh frame; and
connect the first data output channel to the second data line and connect the first auxiliary output channel to the first data line in the second time period during the refresh frame.

17. The display device of claim 16, wherein:
the source driver is further configured to float the first data output channel and to output a line stabilization voltage via the first auxiliary output channel during a skip frame preceding or following the refresh frame;
the multiplexer circuit is further configured to connect the first auxiliary output channel simultaneously to the first data line and the second data line during the skip frame; and
the first data line and the second data line are further configured to receive the line stabilization voltage during the skip frame.

18. The display device of claim 16, wherein:
the source driver is further configured to float the first data output channel and to output an on-bias stress (OBS) voltage via the first auxiliary output channel during an OBS period within the refresh frame, the OBS period being outside the first time period and the second time period in the refresh frame;
the multiplexer circuit is further configured to connect the first auxiliary output channel simultaneously to the first data line and the second data line during the OBS period; and
the first data line and the second data line are further configured to receive the OBS voltage during the OBS period.

19. The display device of claim 15, wherein:
the display panel includes a plurality of red (R), green (G), and blue (B) pixels;
the first pixel and the second pixel are pixels of a same color among the plurality of R, G, and B pixels;
the source driver includes a plurality of data output channels to output corresponding data voltages respectively for the R, G, and B pixels, the plurality of data output channels including the first data output channel; and
the source driver is configured to output the first or second pre-charge voltage via the first auxiliary output channel commonly for the R, G, and B pixels.

20. The display device of claim 15, wherein:
the display panel includes a plurality of red (R), green (G), and blue (B) pixels;
the first pixel and the second pixel are pixels of a same color among the plurality of R, G, and B pixels; and
the source driver includes:
a plurality of data output channels to output corresponding data voltages respectively for the R, G, and B pixels, the plurality of data output channels including the first data output channel; and
a plurality of auxiliary output channels to output corresponding pre-charge voltages respectively for the R, G, and B pixels, the plurality of auxiliary output channels including the first auxiliary output channel.
